(19) United States
(12) Patent Application Publication
(10) Pub. No.: US 2004/0189246 A1
(43) Pub. Date: Sep. 30, 2004

(54) System and method for inductive charging a wireless mouse

(76) Inventors: Claudiu Bulai, Redmond, WA (US); David Nieresher, Renton, WA (US)

Correspondence Address: JAMES L DAVISON, 19822 226TH AVENUE N.E., WOODINVILLE, WA, 98072

(21) Appl. No.: 10/737,483

(22) Filed: Dec. 16, 2003

Related U.S. Application Data
(60) Provisional application No. 60/436,225, filed on Dec. 23, 2002.

(51) Int. Cl. H02J 7/00

(52) U.S. Cl. 320/108

(57) ABSTRACT

A system for using inductive coils to transfer energy to a wireless mouse thereby allowing the wireless mouse to refresh its rechargeable batteries while at the same time being operated over the surface containing the sending inductive coil or coils.

### CROSS-REFERENCE TO RELATED APPLICATIONS

This application is entitled to the benefit of provisional Patent Application Ser. # 60/436,225 filed Dec. 23, 2002.

### BACKGROUND—FIELD

The convenience of using a wireless mouse is offset by the necessity of periodically replacing the mouse battery. A typical wired mouse uses power provided to it by the computer. The power travels from the computer communications port, or in the alternative—the mouse port, through the cable and to the mouse, thereby energizing the mouse allowing the mouse to work without a battery. A wireless mouse cannot use the computer power since there is no physical connection between the mouse and the computer. Therefore a wireless mouse must use an independent power source that heretofore has been either a non-rechargeable battery or a rechargeable battery. Using a non-rechargeable battery results in having to replace the battery at periodic intervals as mentioned above. A mouse with a rechargeable battery uses an energized docking port that physically interfaces with battery contacts on the mouse during the battery charging interval. If the user forgets to dock the mouse after use there is a likelihood that the mouse will eventually drain the battery below the battery's operating voltage whereby the mouse will discontinue operating until it is again ported and recharged. It is then likely that the user must wait at least some time before the mouse is operational again. The present invention obviates the use of a docking station, and the resulting necessity of remembering to dock the mouse after use, by using the mouse pad itself as an inductive charging device. The pad therefore continually refreshes the mouse's battery charge whether the mouse is being used or as it is resting on the pad.

### SUMMARY

The present invention eliminates the requirement of replacing non-rechargeable batteries in a wireless mouse or of using a docking station to charge rechargeable batteries in a wireless mouse.

The present invention is directed toward a system and method that recharges the batteries of a wireless mouse using an inductive coil integrated within a mouse pad. The mouse pad, being stationary, is conveniently wired to a power source. The wireless mouse uses a receiving induction coil accepting the inductive charge from the pad coil or coils. The inductive charge energy is then converted to the appropriate current and voltage to recharge the rechargeable wireless mouse battery and the energy is then used in the same way the power is used in a standard wired mouse or in a standard wireless mouse using non-rechargeable batteries.

### BRIEF DESCRIPTION OF THE DRAWINGS

The invention is further described in connection with the accompanying drawings, in which:

FIG. 1 shows the computer, the mouse pad, and the wireless mouse.

FIG. 2 shows the wireless mouse with the pickup coil and the wired mouse pad with the generating coil attached to an external energy source.

FIG. 3 shows a cross-section view of the wireless mouse with the pickup coil, a charger device connected to an energy storage device.

FIG. 4 shows the type of signals necessary for inductive charging.

### DETAILED DESCRIPTION

The present invention eliminates the requirement of replacing non-rechargeable batteries in a wireless mouse or of using a docking station to charge rechargeable batteries in a wireless mouse.

The present invention is directed toward a method and apparatus that recharges the batteries of a wireless mouse using an inductive coil integrated with a mouse pad. The mouse pad, being stationary, is conveniently wired to a power source. The wireless mouse uses a receiving induction coil or coils for accepting the inductive charge generated out from the pad coil or coils. The inductive charge energy is then converted to the appropriate current and voltage required for recharging the rechargeable wireless mouse battery. The wireless mouse is then used in the same way as a standard wired mouse or a standard wireless mouse using non-rechargeable batteries is used.

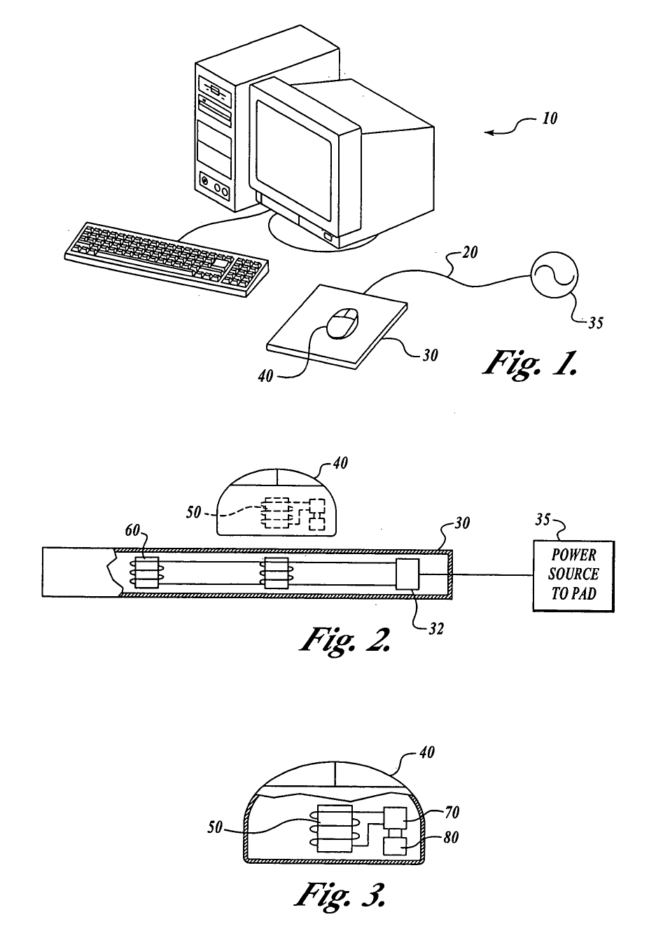

In FIG. 1 the wireless mouse 40 is shown positioned onto the wired mouse pad 30. The mouse pad is wired 20 to an external power source that provides the energy to the mouse pad coil 60 in FIG. 2. The external power source in the preferred embodiment is the USB port provided by the associated computer. Alternative sources of energy may also be used such as other computer ports, wall outlets or even a solar panel. For the most efficient transfer of energy between the mouse pad coil, 60 in FIG. 2, and the wireless mouse coil, 50 in FIG. 2, the distance separating the two coils should be minimized. FIG. 2 shows the positioning of the two coils in relationship to each other.

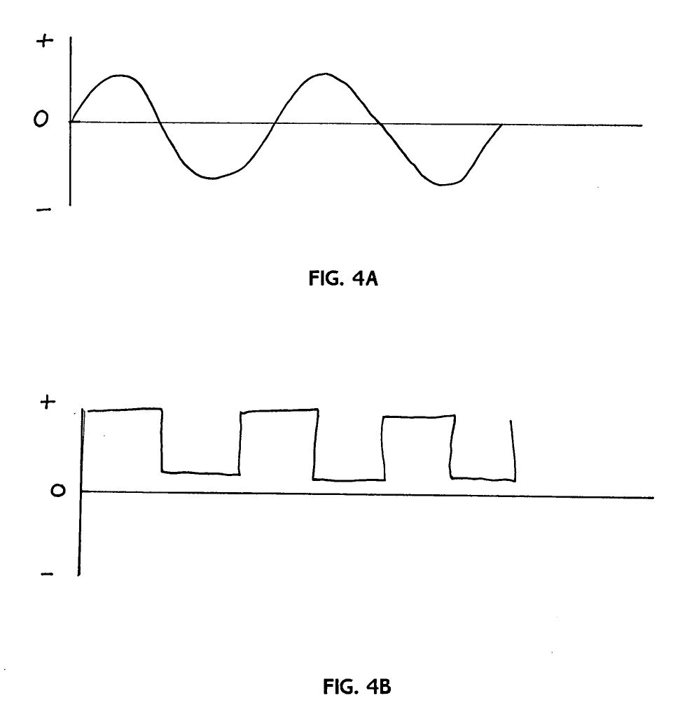

FIG. 3 shows an internal view of the wireless mouse. The wireless mouse coil 60 is attached to a charging device 70 that provides the appropriate charging current to the mouse storage device. In the preferred embodiment, the mouse storage device is a rechargeable battery. Inductive power transfer between devices is well known in the art. The A.C. power source to the mouse pad can come directly and unmodified from an external power source or may come from an external power source and be conditioned to the correct current, voltage and frequency or may even come from a D.C. source and then converted to the appropriate alternating current, voltage and frequency. These types of power conversions are also well known in the art. FIG. 4A shows that the A.C. can be both the traditional alternating current where the current reverses at a regular rate or the alternating current can be varying direct current as seen in FIG. 4B. The inductive coil in the mouse pad may be comprised of a single coil or a plurality of coils either encompassing the entire volume of the pad or encompassing a smaller “docking” area of the pad. This docking area is different from the present art in that the present art docking operation requires a physical connection between the device being charged and the device doing the charging. The coil or coils may have either an iron core or an air core. The electromagnetic field generated by the coil(s) is then transferred to the receiving coil(s) in the wireless mouse. This A.C. field generated in the receiving coil(s) is then rectified to the appropriate D.C. charging current and provided to the wireless mouse storage device, preferably a rechargeable battery. Note that in other embodiments, since there need be no contact between the wireless mouse and the sending inductive coils, the sending coils may be mounted in other orientations to the wireless mouse. An example would be to mount the coils under a desk surface. Preferably however, the sending coils and the receiving coils should be closer together for efficient energy transfer rather than farther apart. Also in the preferred embodiment there is an indication, such as a light or other device, showing the user that the mouse pad is energized and another light or indication to the user that the wireless mouse is acceptably receiving the inductive energy from the mouse pad and is appropriately recharging the rechargeable battery.

Therefore, although the invention has been described as setting forth specific embodiments thereof, the invention is not limited thereto. Changes in the details may be made within the spirit and the scope of the invention, said spirit and scope to be construed broadly and not to be limited except by the character of the claims appended hereto.

We claim:

1. A system to charge a wireless mouse battery using inductive coupling from an energized mouse pad comprising:
a) at least one energy transmitting coil in the mouse pad with said coil having means for receiving the appropriate current and voltage for activating the coil from an attached energy source;
b) at least one receiving coil in the wireless mouse for accepting transferred energy; and
c) said wireless mouse having means for converting said transferred energy to the appropriate current and voltage for charging said wireless mouse battery.

2. The system of claim 1 wherein the means for receiving the appropriate current and voltage for activating the coil from an attached energy source comprises a current limiter and an oscillating circuit when said attached energy source is a D.C. source.

3. The system of claim 1 wherein the means for activating the coil from an attached alternating current energy source comprises a circuit for modifying said alternating current source to the appropriate current and voltage.

4. The system of claim 1 wherein the wireless mouse means for converting said transferred energy to the appropriate current and voltage for charging said wireless mouse battery comprises a rectifier circuit and a charge controller circuit.

5. The system of claim 1 further including a mouse pad power-on indication to the user.

6. The system of claim 1 further including a wireless mouse power-on indication to the user.

7. A method for inductively charging a rechargeable battery contained in a wireless mouse comprising:
a) attaching a mouse pad containing inductive coils to a power source;
b) conditioning power from said source to the appropriate current and voltage to activate said inductive coils;
c) inductively transferring power to at least one receiving coil located in said wireless mouse; and
d) appropriately conditioning said transferred power after receipt and allowing said conditioned power to recharge the battery.

8. A means for inductively charging a rechargeable battery contained in a wireless mouse comprising:
a) means for receiving power to a mouse pad;
b) means for transforming said received power to possess the appropriate characteristics to drive at least one induction coil;
c) means for the wireless mouse to receive power from said mouse pad induction coil; and
d) means for conditioning said received power so that said received power has the appropriate characteristics to recharge the rechargeable battery.
